(19) United States
(12) Patent Application Publication
(10) Pub. No.: US 2012/0203602 A1
(43) Pub. Date: Aug. 9, 2012

(54) ADVERTISEMENT DELIVERY SYSTEM TRIGGERED BY SENSED EVENTS

(76) Inventor: Bradley J. Walters, Kaysville, UT (US)

(21) Appl. No.: 13/022,423

(22) Filed: Feb. 7, 2011

(51) Int. Cl. G06Q 30/00

(52) U.S. Cl. 705/14.5

(57) ABSTRACT

An advertisement delivery method distributes one or more advertisements to monitoring service subscribers via text messaging (MMS or SMS), a voice message, an email message, on-line pop-up notification, notification in an application user interface (including on-line forums such as Twitter and Facebook), an instant message and/or phone call in response to the receipt, by a gateway, of sensor signals indicative of at least one event, trigger, time-based reading or breach of a threshold. The advertisements need not be delivered by the same means used to deliver the sensor notifications. The subscribers may respond to the advertisements by calling the advertisers directly in order to inquire about the advertised services or to order such services directly. The system can also provide return notifications to the advertisers stating that the ads were, in fact, sent, and providing details of the notifications and identification of the ad recipients.

### FIELD OF THE INVENTION

This invention relates, generally, to electronic advertisement delivery systems and, more specifically, to an advertisement delivery system which is triggered by an event identified by an electronic sensor. Advertisements may be delivered by a variety of electronic message delivery systems.

### BACKGROUND OF THE INVENTION

Myriad wired and wireless sensors are available to detect a host of physical conditions, including temperature, motion, moisture, humidity, vibration, light, proximity, electrical potential, the presence of smoke, and open or closed. Many of these physical conditions have associated with them imminent damage concerns that may require the intervention of a licensed professional or other service provider. For example, a manager of an apartment complex or large personal residence may desire to employ moisture sensors in multiple locations to monitor the presence of moisture before severe damage occurs to cabinetry, walls, and ceilings. Leaks detected by moisture sensors beneath sinks in kitchens and bathrooms must be repaired by a plumber before cabinetry is damaged. Moisture detected in attics must be repaired by a roofing contractor in order to prevent damage to drywall and the framing below. Detection of moisture in walls may signify a structural problem that must be remedied by a building contractor before rot occurs. Moisture sensors in docked boats can alert an owner or caretaker that the boat may be sinking. Vibration sensors on air-conditioning and heat-pump compressors can generally sense when equipment failure is imminent. Light detectors installed on or within objects stored beneath covers can indicate that the cover needs to be replaced. Sensors installed in an unoccupied building that sense both a main power failure and exterior temperatures below freezing may portend the bursting of interior water pipes. Immediate action is required to remedy the situation. Sensors associated with unoccupied buildings that sense both a low level of a propane tank and dangerously low exterior temperatures can identify an immediate need to refill the propane tank. Moisture detectors in a basement can detect flooding before it becomes severe. One can imagine all types of problems that can be detected by sensors in order to mitigate potential damage. As a general rule, repair and damage costs increase with time after a condition or failure occurs. In any case, being apprised of a problem is only the first step; the problem must be repaired by some competent individual or organization. The present invention takes advantage of this reality.

### SUMMARY OF THE INVENTION

The present invention provides an advertisement, or ad, delivery system that distributes one or more advertisements to one or more monitoring service subscribers via a text message (MMS or SMS), a voice message or call, an email message, on-line pop-up notification, notification in an application user interface (including on-line forums such as Twitter, Facebook, and Skype), an instant message and/or phone call in response to the receipt, by a gateway, of sensor signals indicative of at least one event, trigger, time-based reading or breach of a threshold. The advertisements need not be delivered by the same means used to deliver the sensor notifications. In addition, the service subscribers may, in some situations, respond to the advertisements by calling the advertisers directly or by responding with a text message in order to inquire about the advertised services or to order such services directly. The system can also provide return notifications to the advertisers stating that the ads were, in fact, sent, and providing details of the notifications and identification of the ad recipients.

The heretofore described advertisement delivery system possesses a number of advantages over conventional advertisement delivery systems. Firstly, the system sends advertisements only upon the occurrence of a context-based event, as detected by one or more pre-programmed sensors. The advertisements preferably follow or accompany delivery of notice to the service subscriber(s) of the context-based event detected by the sensor(s). Thus, the service subscribers are presented with ads for services which have the potential to remedy the situation associated with the events identified by the sensors, and which the service subscribers are eager to receive. This is targeted marketing at its best, for the advertisers know that the service subscribers both need and want the advertised services. Secondly, the advertisement delivery system is far more configurable than conventional advertisement delivery systems. Advertisements can be selected for particular geographic locations, specific delivery times or dates can be selected, ad delivery frequency can be varied, and the different types of delivery mechanisms (i.e., phone, email, etc.) can be selected. Thirdly, the advertisement delivery system has more breadth and scalability than traditional advertising. The content of advertisements can be text-based, graphic, audible or multimedia.

### BRIEF DESCRIPTION OF THE DRAWINGS

FIG. 1 is a block diagram of the advertisement delivery method and apparatus of the present invention; and

FIG. 2 is a block diagram of a digital computer server system employed to implement the present invention.

### PREFERRED EMBODIMENT OF THE INVENTION

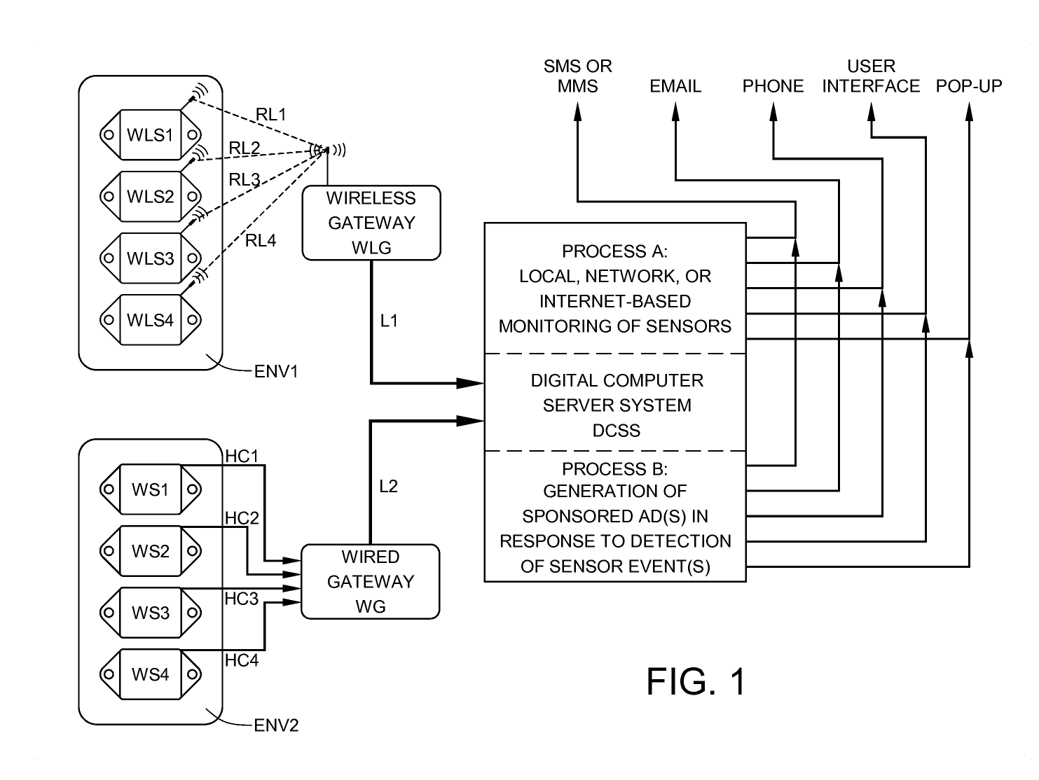

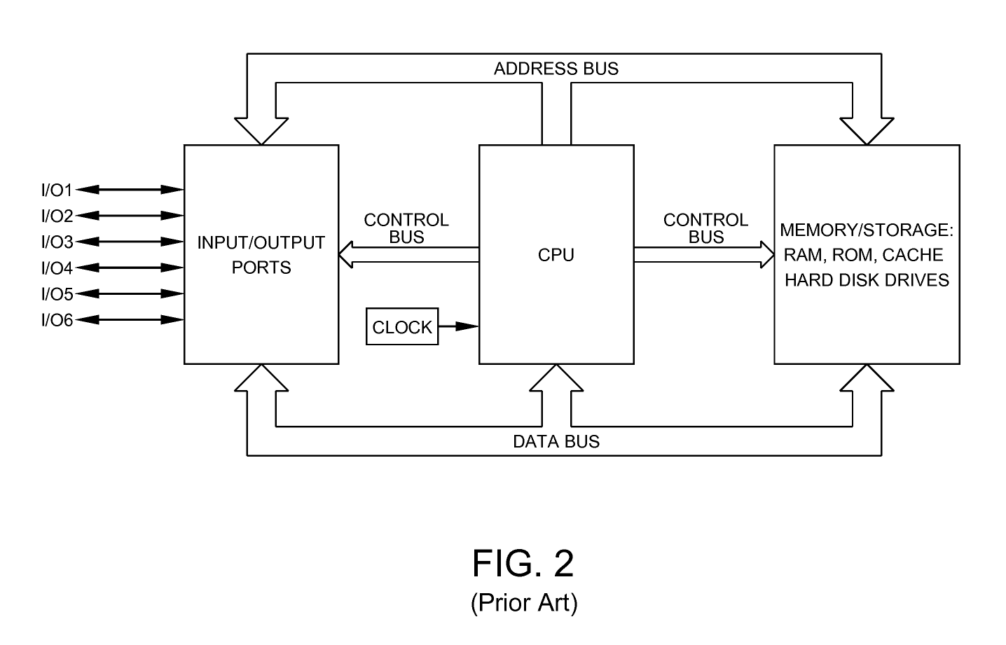

The invention will now be described with reference to the attached drawing FIGS. 1 and 2.

Referring now to FIG. 1, wireless sensors WLS1, WLS2, WLS3 and WLS4 are employed to monitor physical conditions in a first environment ENV1. In addition, wired sensors WS1, WS2, WS3 and WS4 are employed to monitor physical conditions in a second environment ENV2. The wireless sensors WLS1-WLS4 communicate with a wireless gateway WLG via radio-frequency links RL1, RL2, RL3 and RL4, respectively, while the wired sensors WS1-WS4 communicate with a wired gateway WG via hard-wired conductors HC1, HC2, HC3 and HC4, respectively. Clearly, both wireless and wired sensors may be used either separately or simultaneously to monitor physical conditions in a single environment. The wireless gateway WLG is coupled to the input/output ports of a digital computer server system DCSS via a link L1. Likewise, the wired gateway WG is coupled to the input/output ports of a digital computer server system DCSS via a link L2. It should be understood that the links L1 and L2 may be either wired or wireless. The digital computer server system CDSS can be a local stand-alone system, a system coupled to a Local Area Network (LAN), a system coupled to a Wireless Local Area Network (WLAN), a system coupled to a Wide Area Network (WAN), a system coupled to a Metropolitan Area Network (MAN), or a system coupled to an Internet-based network.

Still referring to FIG. 1, the digital computer server system DCSS runs two processes. Process A monitors the wireless and/or wired sensors and notifies a subscriber of the service whenever a sensor reports the occurrence of at least one event, a trigger, a time-based reading or a breach of a set threshold. Notification of the subscriber or of multiple subscribers (e.g., husband and wife) can be through one or more of a variety of means: SMS, MMS, Email, telephone, user interface, or pop-up generation. Short Message Service (SMS) is the text communication service component of phone, web or mobile communication systems, using standardized communications protocols that allow the exchange of short text messages between fixed line or mobile phone devices. Multimedia Messaging Service (MMS) is a standard way to send messages that include multimedia content to and from mobile phones. Email, of course, is an Internet-based text and file delivery. Telephone notification includes both land-line based telephones and cell phones. Notification through a user interface involves the use of a specially-designed subscriber interface running on a desktop computer, a laptop computer, a notebook computer, a tablet computer, a personal digital assistant (PDA), a smart phone, a home security screen, the screen of a digital thermostat, or any other type of computer hardware or embedded device accessible by the subscriber that provides status information for sensors covered by the service subscription. User interface notification can also involve the delivery of messages and ads to social networking sites, such as Facebook, Twitter and Skype, in which a subscriber participates. Pop-up notification is notification sent via the Internet to the subscriber's browser that alerts the subscriber of any physical condition that has crossed a threshold that was set by Process A of the subscriber's monitoring service.

Still referring to FIG. 1, Process B, the second of the two processes being run on the digital computer server system DCSS, generates ads which are specifically tailored to rectifying damages caused by a sensor event. For example, a detection of the presence of moisture beneath a sink in a kitchen or bathroom would result in the generation of an ad for a plumber; detection of moisture in an attic would result in the generation of an ad for a roofing contractor; detection of moisture in walls would result in the generation of an ad for a building contractor; moisture detection in a docked boat would result in the generation of an ad for a nearby boat service shop; sensing of extraordinary vibration on an air-conditioning or heat pump compressor would result in the generation of an ad for a heating, ventilation, and air-conditioning contractor; the sensing of a main power failure coupled with exterior temperatures below freezing might be programmed to generate an ad for a clean-up service company; detection of a low level of fuel within a propane tank and dangerously low exterior temperatures would result in the generation of an ad for a propane delivery service; and detection of moisture in a basement might result in the generation of ads for both a clean-up service and a plumber.

The ads generated in Process B may be sent to a subscriber at the same time that notification of the sensor threshold alarm is sent, or they may be sent after a predetermined period of delay. In all cases, the generated and delivered ads are intended to assist the subscriber in rectifying the conditions (including damage) associated with a threshold breach, timed event, or triggered event detected by a sensor. The advertisements need not be delivered by the same means used to deliver the sensor notifications. In addition, the service subscribers may, in some situations, respond to the advertisements by calling the advertisers directly in order to inquire about the advertised services or to order such services directly. The system can also provide return notifications to the advertisers stating that the ads were, in fact, sent, and providing details of the notifications and identification of the ad recipients.

Referring now to FIG. 2, a conventional digital computer server system (DCSS) is employed by the condition monitoring service of Process A and by the ad generation service of Process B. The DCSS has a central processing unit (CPU), a clock, a control bus, an address bus, a data bus, memory and data storage, as well as input/output section having a plurality of input/output ports I/O1-I/O6. Although most PC-based digital computer server systems can run nearly any modern operating system, such as GNU/Linux, BSD, OSX, or Windows Server, the use of GNU/Linux for server operating systems is growing rapidly because of its flexibility, security and reliability. The CPU, or “processor”, is made up of the control unit and arithmetic logic unit (ALU). Today, the CPUs of almost all computers are contained on a single chip. The control bus is a communications channel used by the CPU for communicating with other devices within the computer; it carries commands from the CPU and returns status signals from the devices. The address bus is a communications channel that carries addresses from the central processing unit to components under the unit's control. The data bus is a bidirectional parallel communications channel involving the transfer of data and instructions between areas of function within the computer. It can transmit information in only one direction at a time. In addition to data, the data bus transfers instructions from memory to the CPU.

Ads from subscribing businesses are categorized and stored in a database on a hard disk drive or other storage medium associated with the DCSS. When a notification regarding a sensed physical condition is sent to a subscriber of the monitoring service, an add associated with that particular physical condition is also sent, either contemporaneously or subsequently, to the subscriber. Ads from different subscribing businesses, associated with the same type of event, can be sent in rotation, or multiple ads can be sent for a single event. The system is highly flexible and can be programmed to provide any desired response following detection by the sensors of an event. For example, the advertisements can be created or generated and sent in a random or sporadic way from a database of advertisers. Conversely, the ads can be created or generated and sent in an ordered (e.g., sequential) manner.

All communication with the outside world is accomplished through the input/output ports of the DCSS. Each port may be dedicated to a particular function, or it may be multiplexed to handle several functions. Thus, monitoring signals are received through the input/out ports. Notifications of at least one event, trigger, time-based reading or breach of a threshold (generally, a physical condition predetermined to merit the attention of the subscriber) are also sent through the input/output ports, as are the ads generated in response to the event(s) triggering the notification(s). An example of a time-based reading might be the use of a sensor coupled to the Hobbs meter on a private aircraft. At intervals mandated by the Federal Aviation Administration (FAA), the owner is alerted whenever service must be performed on the airframe or engine, based on the total flying time of the aircraft, the elapsed operational time since the last major overhaul of the engine, or the elapsed operational time since the last overhaul of the propeller. Such service intervals are critically important when an aircraft is offered for hire by third parties. Other like situations can be easily imagined.

The present invention has three opportunities for revenue generation. The first is the revenue generated by installing the sensors and setting up the monitoring system for the individual subscribers. The second is the revenue generated by the ongoing subscription charged for monitoring the desired physical conditions. The third is the revenue generated by subscribing businesses which desire to participate in the ad generation process. Thus, tasks associated with monitoring of Process A can be charged to a first group of subscribers who desire to have their property monitored, and ad generation associated with Process B can be charged to a second group of subscribers—those businesses that want to be introduced to the first group of subscribers when services are required to rectify conditions signaled by the sensors.

Although only several variations of a single embodiment of the invention have been heretofore disclosed and described, it will be obvious to those having ordinary skill in the art that changes and modifications may be made thereto without departing from the scope and the spirit of the invention as hereinafter claimed.

What is claimed is:

1. An advertisement delivery system triggered by sensed events comprising:
at least one sensor located at a monitored suite, said at least one sensor emitting periodic signals indicative of at least one physical condition;
a gateway for receiving signals from said at least one sensor;
a digital computer server system coupled to said gateway, said server system providing monitoring of periodic signals emitted by said at least one sensor, said server system sending notification to at least one monitoring service subscriber whenever a signal from said at least one sensor indicates a change in said at least one physical condition that was predetermined to merit attention of said at least one monitoring service subscriber, said server system also generating at least one advertisement targeted at dealing with the change in physical condition and transmitting said at least one advertisement to said at least one monitoring service subscriber.

2. The advertisement delivery system of claim 1, wherein said sensors are selected from the group consisting of wireless and wired sensors.

3. The advertisement delivery system of claim 1, wherein notification to said at least one monitoring service subscriber is sent by at least one method selected from the group consisting of SMS, MMS, Email, telephone, user interface messaging and pop-up generation for browser-equipped computer devices used by the subscriber.

4. The advertisement delivery system of claim 1, wherein a change in said at least one physical condition meriting attention occurs when a sensor signal indicates that at least one triggering event has occurred.

5. The advertisement delivery system of claim 1, wherein a change in said at least one physical condition meriting attention occurs when a particular time-based reading occurs.

6. The advertisement delivery system of claim 1, wherein a change in said at least one physical condition meriting attention occurs when breach of a pre-programmed threshold occurs.

7. The advertisement delivery system of claim 1, wherein said digital computer server system is selected from the group consisting of local server systems, network-based server systems and internet-based server systems.

8. A method of delivering advertisements triggered by sensed events, the method comprising the steps of:
establishing a monitoring service which
accepts subscriptions from a first group of subscribing entities desiring to monitor at least one physical condition in an identified environment;
installs sensors to monitor at least one physical condition in identified environments on behalf of particular entities from the first group;
installs at least one gateway for receiving signals from the installed sensors;
provides at least one digital computer server system that is coupled to said at least one gateway for monitoring signals received from each of the sensors;
creates a database having advertisements for services provided by a second group of entities which are selected to deal with events sensed by the installed sensors;
notifying at least one entity of the first group whenever a signal from a sensor associated with that entity indicates a change in said at least one physical condition, which was predetermined to merit attention of the notified at least one subscribing entity; and
transmitting at least one advertisement, selected from the database, to said at least one entity of the first group for a service that targets addressing said change in physical condition meriting attention of the notified at least one subscribing entity.

9. The method of delivering advertisements of claim 8, wherein each sensor is selected from the group consisting of wireless and wired sensors.

10. The method of delivering advertisements of claim 8, wherein notification sent to said at least one subscribing entity of the first group is delivered by a method selected from the group consisting of SMS, MMS, Email, telephone, user interface messaging and pop-up generation for browser-equipped computer devices used by the subscribing entity.

11. The method of delivering advertisements of claim 8, wherein a change in physical condition predetermined to merit attention occurs when a sensor signal indicates that at least one triggering event has occurred.

12. The method of delivering advertisements of claim 8, wherein a change in physical condition predetermined to merit attention occurs when a particular time-based reading occurs.

13. The method of delivering advertisements of claim 8, wherein a change in physical condition predetermined to merit attention occurs when breach of a pre-programmed threshold occurs.

14. The method of delivering advertisements of claim 8, wherein said digital computer server system is selected from the group consisting of local server systems, network-based server systems and internet-based server systems.

15. The method of delivering advertisements of claim 8, wherein said monitoring service charges entities belonging to the second group whenever an advertisement for its services is sent to an entity of the first group.

16. The method of delivering advertisements of claim 8, wherein the monitoring service also provides return notifications to the advertisers stating that certain advertisements were, in fact, sent, and providing details of the notifications and identification of the advertisement recipients.

17. An advertisement delivery system triggered by sensed events comprising:
at least one sensor located at a monitored suite, said at least one sensor emitting periodic signals indicative of at least one physical condition;
a gateway for receiving signals from said at least one sensor;
a digital computer server system coupled to said gateway, said server system providing monitoring of periodic signals emitted by said at least one sensor, said server system sending notification to at least one monitoring service subscriber whenever a signal from said at least one sensor indicates that a change has occurred in said at least one physical condition that merits attention of said at least one monitoring service subscriber, said server system also having a database in which is stored advertisements for goods and services selected to deal with changes in physical conditions being monitored, said server transmitting at least one advertisement from the database, that is targeted at said change in physical condition, to said at least one monitoring service subscriber.

18. The advertisement delivery system of claim 17, wherein said sensors are selected from the group consisting of wireless and wired sensors.

19. The advertisement delivery system of claim 17, wherein notification to a monitoring service subscriber is sent by at least one method selected from the group consisting of SMS, MMS, Email, telephone, user interface messaging and pop-up generation for browser-equipped computer devices used by said at least one monitoring service subscriber.

20. The advertisement delivery system of claim 17, wherein a change in physical condition meriting attention occurs when a sensor signal indicates the happening of an occurrence selected from the group consisting of a triggering event, a time-based reading, and breach of a pre-programmed threshold.
